(19) United States
(12) Patent Application Publication
(10) Pub. No.: US 2008/0149562 A1
(43) Pub. Date: Jun. 26, 2008

(54) METHODS AND SYSTEMS FOR DELIVERING SCALE INHIBITOR

(76) Inventors: Ronald Scott Tarr, Louisville, KY (US); Timothy Worthington, Crestwood, KY (US); Derek Lee Watkins, Elizabethtown, KY (US)

Correspondence Address: Alan G. Gorman;Merchant & Gould, L.L.C., P.O. Box 2903, Minneapolis, MN, 55402, US

(21) Appl. No.: 11/613,336

(22) Filed: Dec. 20, 2006

(51) Int. Cl. C02F 1/44

(52) U.S. Cl. 210/637; 210/97

(57) ABSTRACT

Systems and methods for injecting a fluid into a system are disclosed. The systems include a capillary tube having an inlet and an exit. The capillary tube being configured to release the fluid from a bladder when there exists a pressure difference between the inlet of the capillary tube and the exit of the capillary tube. The pressure difference being caused by a redirection attachment. The methods include causing a pressure differential within a first container. The pressure differential applies pressure to a bladder forcing the fluid to flow from the bladder through a capillary tube.

### REFERENCE TO CROSS-RELATED APPLICATIONS

The present application is related to U.S. patent application having Ser. No. 10/982,731 which is hereby incorporated in its entirety by reference.

### FIELD OF INVENTION

Embodiments of the present invention relate to injecting a fluid into a system. More specifically, embodiments of the present invention relate to systems and methods for injecting scale inhibitor into reverse osmosis systems.

### BACKGROUND OF THE INVENTION

In order to operate at high efficiencies, reverse osmosis systems recirculate concentrate water back into a feed side of a membrane. When reverse osmosis systems operate at high efficiencies, there is a high concentration of ions in the water. This high concentration of ions can result in precipitation of scale (CaCO₃) within the reverse osmosis system and on the membrane.

A scale inhibitor can be used to reduce the likelihood of scale precipitation. Current methods used to deliver scale inhibitor consist of flowing water past a crystalline scale inhibitor wherein the scale inhibitor dissolves into the flowing water. The problem arises in that during periods when the system is not in operation, the scale inhibitor continues to dissolve into the reverse osmosis system's water. Another method used to deliver scale inhibitor consists of pumping the scale inhibitor into the system through the use of metering pumps. The use of metering pumps is expensive. There exists a need for inexpensive methods and systems that deliver scale inhibitor only during operation of the reverse osmosis system.

### BRIEF DESCRIPTION OF THE INVENTION

Consistent with embodiments of the present invention, systems for fluid delivery are disclosed. The systems include a container, a bladder located inside the container, and a capillary tube having an inlet and an exit. The capillary tube may be configured to release the fluid from the bladder when there exists a pressure difference between the inlet of the capillary tube and the exit of the capillary tube. The pressure difference may be caused by a pressure buildup inside the container.

Still consistent with embodiments of the present invention, methods for injecting a fluid into a system are disclosed. The methods include causing a pressure buildup within a first container. The pressure buildup applies pressure to a bladder. In response to the applied pressure, the fluid is forced from the bladder through a capillary tube into the system.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts an assembly configured to inject a fluid into a system;

FIG. 2 depicts a cross-section of the assembly shown in FIG. 1;

FIG. 3 depicts a partial cross-section of the assembly shown in FIG. 1;

FIG. 4 depicts a cross-section of the assembly of FIG. 1 configured for installation in a piping system;

FIG. 5 depicts an assembly configured to inject a fluid into a system;

FIG. 6 depicts a replaceable container for use in the assembly shown in FIG. 5;

FIG. 7 depicts a cross-section of the assembly shown in FIG. 5;

FIG. 8 depicts a partial cross-section of the assembly shown in FIG. 5;

FIG. 9 depicts a partial cross-section of the assembly shown in FIG. 5;

FIG. 10 depicts a schematic of a system for injecting a fluid into a system;

FIG. 11 depicts a schematic for a system for injecting a fluid into a system; and

FIG. 12 depicts a container used in the system shown in FIG. 10 and FIG. 11.

### GENERAL DESCRIPTION

Reference may be made throughout this specification to “one embodiment,” “an embodiment,” “embodiments,” “an aspect,” or “aspects” meaning that a particular described feature, structure, or characteristic may be included in at least one embodiment of the present invention. Thus, usage of such phrases may refer to more than just one embodiment or aspect. In addition, the described features, structures, or characteristics may be combined in any suitable manner in one or more embodiments or aspects. Moreover, reference to a single item may mean a single item or a plurality of items, just as reference to a plurality of items may mean a single item. Furthermore, while water is used throughout this specification, it is contemplated that the disclosed systems and methods may be used in conjunction with other fluids.

Embodiments of the present invention utilize a bladder containing a fluid to be injected into a system. A pressure may be applied to the bladder causing the fluid to pass through a capillary tube operatively connected to the bladder. The bladder may be housed in a container.

Other aspects of the invention include having a valve to control the flow of fluid from the bladder. Further aspects of the invention include a sensor to monitor the system and the sensor controlling the valve thereby controlling the flow of fluid from the bladder.

### DETAILED DESCRIPTION

Various embodiments are described more fully below with reference to the accompanying drawings, which form a part hereof, and which show specific embodiments of the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Accordingly, the following detailed description is, therefore, not to be taken in a limiting sense.

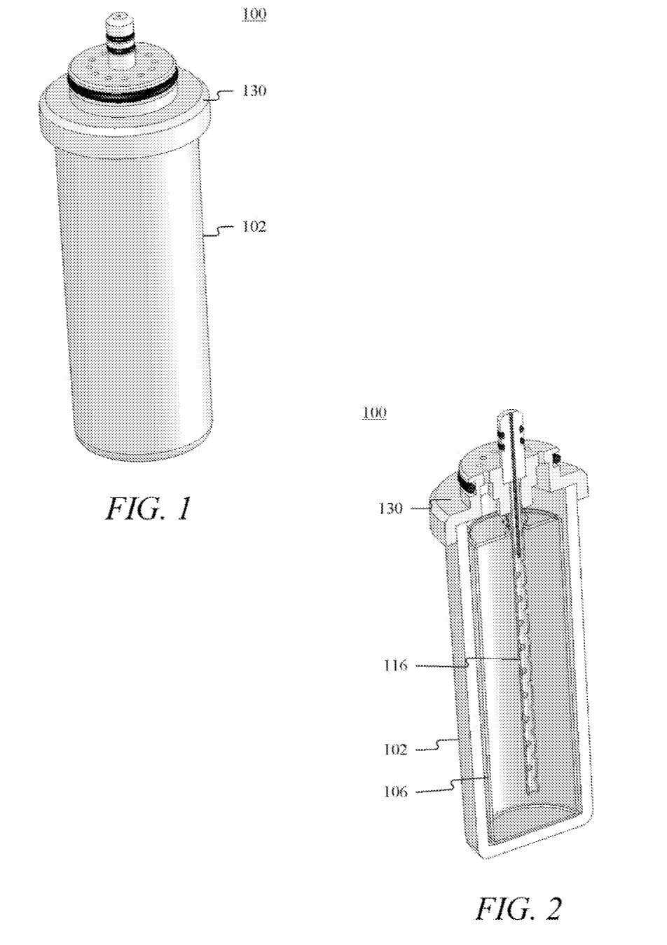

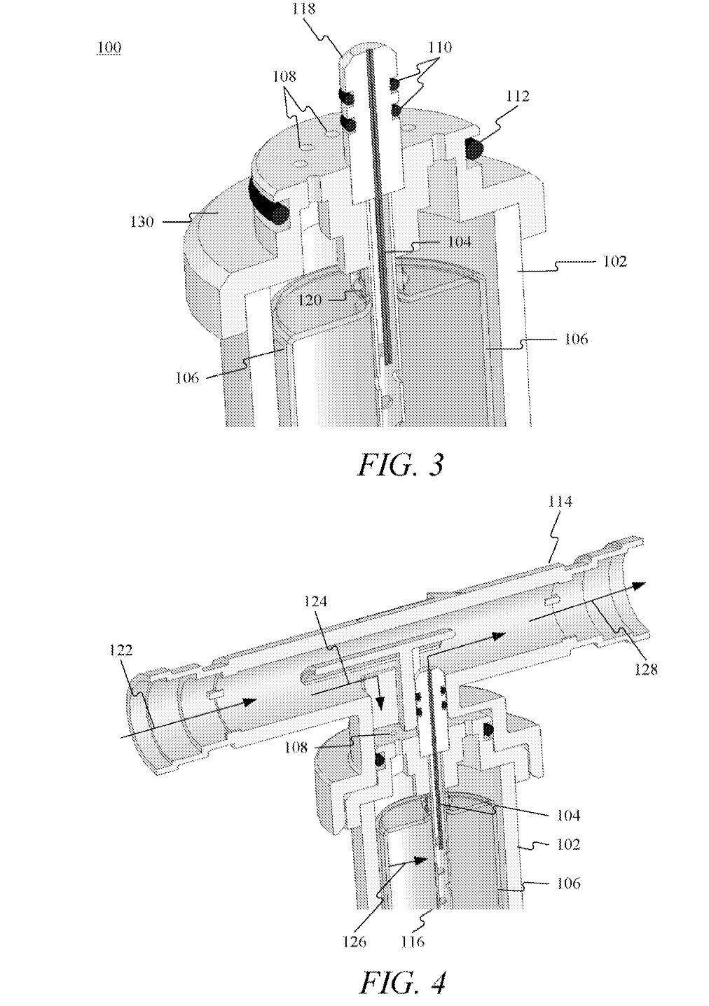

Referring now to the figures, FIGS. 1, 2, and 3 depict an assembly 100 configured to inject a fluid into a system. FIG. 2 depicts a cross-section of the assembly 100. FIG. 3 depicts a detailed view of the functioning end of the assembly 100. The assembly 100 includes a container 102, a capillary tube 104, and a bladder 106.

During operation, water enters orifices 108 located in the container 102. The water in the container 102 may apply pressure to the bladder 106. The pressure exerted on the bladder 106 causes scale inhibitor to flow through the capillary tube 104 into a system.

The flow rate of the scale inhibitor is controlled by a pressure difference from the inlet and the exit of the capillary tube 104. The pressure drop across the capillary tube 104 may be controlled by the diameter and/or length of the capillary tube 104. Alternate method for controlling the flow rate of the scale inhibitor may be to control the pressure applied to the bladder 106.

The assembly 100 may further include a perforated tube 116. The perforated tube 116 may act to help maintain the capillary tube 104 in a desired shape. For example, the perforated tube 116 may act to keep the capillary tube 104 straight and/or keep it from kinking. In addition, the perforated tube 116 may act to keep the inlet of the capillary tube 104 from becoming blocked by the bladder 106. Furthermore, the perforated tube 116 may also prevent part of the bladder 106 from “pinching off.” Pinching off is the trapping of fluid (e.g. scale inhibitor) in a lower portion of the bladder 106. For example, without the perforated tube 116, the bladder 106 may be squeezed at an upper portion versus the lower portion thereby pinching off the bladder 106 so that scale inhibitor will not flow. This would be akin to squeezing a tube of toothpaste from the top. Furthermore, the bladder 106 may be connected to the perforated tube 116 by a clamp 120.

In addition, the assembly 100 may include O-rings 110 and 112 for forming a seal between the assembly 100 and a fixture 114 (See FIG. 4). Furthermore, the assembly 100 may include a plug 118. The plug 118 may be used to connect the capillary tube 104, the perforated tube 116, and/or other components to the container 102.

For example, assembly 100 may be assembled as follows. The perforated tube 116 may be attached to a container cap 130. By way of example and not limitation, the perforated tube 116 may be attached to the container cap 130 by plastic weld, ultrasonic weld, spin weld, glue, etc. In is contemplated that the perforated tube 116 and the container cap 130 may be a single piece manufactured by methods including but not limited to injection molding and casting. Bladder 106 may be attached to the perforated tube 116 with the clamp 120 or other suitable attachment methods including but not limited to plastic weld, melting, adhesive, etc.). The container 102 may be attached to container cap 130 via plastic weld, utrasonic weld, spin weld, glue, screws, etc. Bladder 106 may then be filled with scale inhibitor. A subassembly consisting of the plug 118 and the capillary tube 104 may be assembled thru an interference fit, inserting a hot capillary into the plastic plug, etc. Finally, the plug 118 may be inserted into the container cap 130 to complete the assembly.

Turning now to FIG. 4, a cross-section of the assembly in FIG. 1 is shown configured for installation in a piping system. The assembly 100 is connected to the fixture 114. Water flows into the fixture 114 (as symbolized by arrow 122) where a portion of the water flow is diverted through orifices 108 into the container 102 (as symbolized by arrow 124). The portion of the water flow diverted into the assembly 100 applies a pressure to the bladder 106. The pressure exerted on the bladder 106 causes scale inhibitor to flow through the perforated tube 116 and into the capillary tube 104 (as symbolized by arrow 126). The capillary tube 104 regulates the flow of scale inhibitor based on the pressure difference between the inlet and exit of the capillary tube 104. Upon exiting the capillary tube 104 the scale inhibitor is carried out of the fixture 114 (as symbolized by arrow 128).

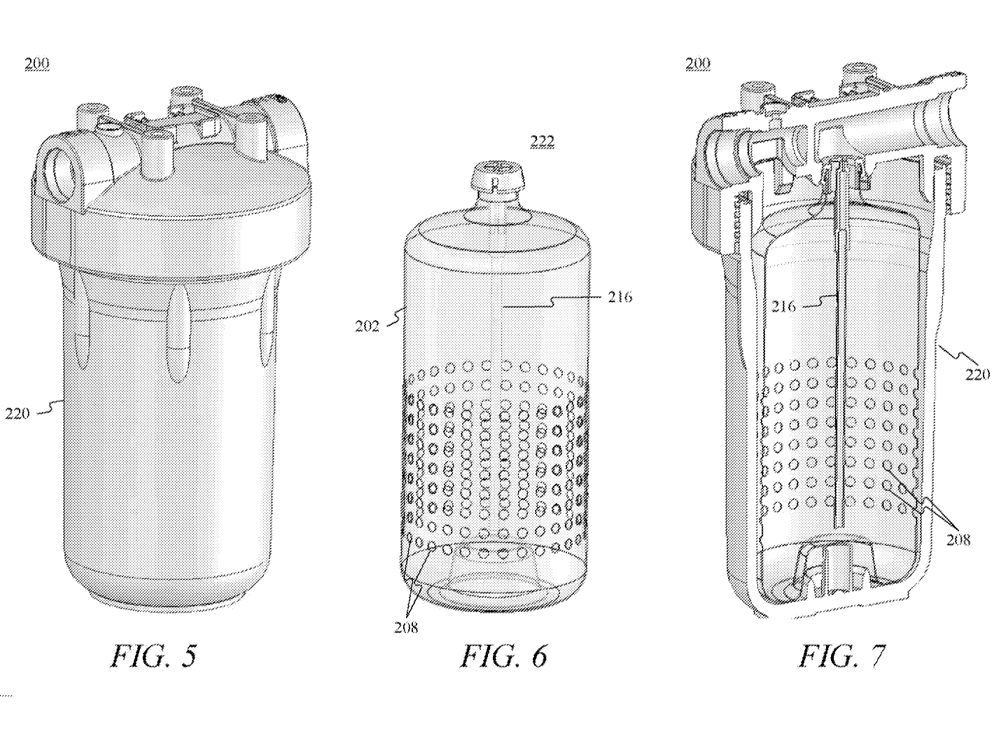

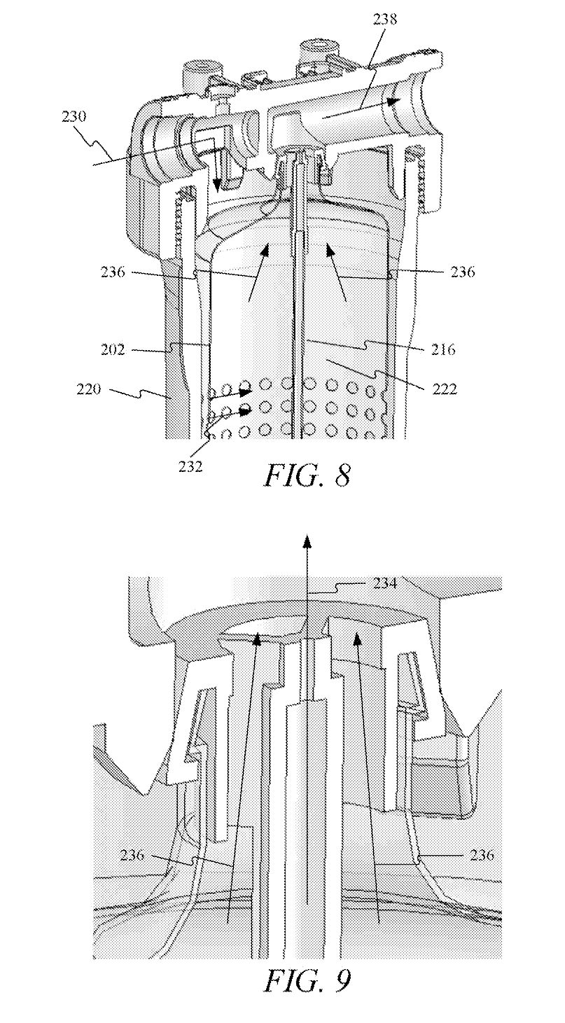

Referring now to FIGS. 5-9, FIG. 5 depicts an assembly 200 configured to inject a fluid into a system. The assembly includes a filter sump 220. The filter sump 220 may be a standard cartridge filter housing such as those distributed by GRAINGER and MACMASTER-CARR. FIG. 6 depicts an insert 222 which may be used with the filter sump 220.

Insert 222 includes a container 202, a deformable bladder (not shown), and a capillary tube (not shown). During operation, water enters orifices 208 located in the container 202. The water in the container 202 may apply pressure to the bladder. The pressure exerted on the bladder (not shown) causes scale inhibitor to flow through the capillary tube (not shown) into a system.

As with assembly 100, the flow rate of the scale inhibitor is controlled by a pressure difference from the inlet and the exit of the capillary tube. The pressure drop across the capillary tube may be controlled by the diameter and/or length of the capillary tube. Other ways to control the flow rate of the scale inhibitor may be to control the pressure applied to the bladder.

The insert 222 further includes a perforated tube 216. The perforated tube 216 may act to help maintain the capillary tube in a desired shape. For example, the perforated tube 216 may act to keep the capillary tube straight and/or keep it from kinking. In addition, the perforated tube 216 may act to keep the inlet of the capillary tube from becoming blocked by the bladder. In addition, the assembly 200 may include a gasket (not shown) for forming a seal between the insert 222 and a filter sump 220. It is further contemplated that a top portion of the insert, 222, may be made from a rubber or santoprene material. This may form a seal between the container 202 and the assembly 200.

Turning now to FIGS. 8 and 9, a partial cross-section of the assembly in FIG. 5 is shown configured for installation in a piping system. The insert 222 is housed within filter sump 220. During operation, water flows into the filter sump 220 (as symbolized by arrow 230) where all of the water flow is diverted through orifices 208 into the container 202 (as symbolized by arrow 232). The water flow diverted into the container 202 applies a pressure to the bladder. The pressure exerted on the bladder causes scale inhibitor to flow through the perforated tube 216 and into the capillary tube. The capillary tube regulates the flow of scale inhibitor based on the pressure difference between the inlet and exit of the capillary tube. Upon exiting the capillary tube the scale inhibitor is carried out of the insert 222 (as symbolized by arrow 234). The water that entered the container 202 exits the container 202 through an opening proximate the exit of the insert 222 (as symbolized by arrow 236) and exits the filter sump 220 (as symbolized by arrow 238).

The embodiments described in FIGS. 1-9 are continuous flow systems. Continuous flow indicates that when there is fluid flow within the system to which embodiments of the invention are connected, the fluid within the bladder will be injected into the system.

The embodiments described in FIGS. 1-9 may be compact systems which may be utilized in various contexts. For example, the embodiments described in FIGS. 1-9 may be utilized in a residential setting, a laboratory setting, and/or a medical/dental setting. For example, if an embodiment of the invention is utilized in a dental setting, the fluid in the bladder may be a fluoride solution to be administered to patients. In another embodiment, the fluid flow may be air and the fluid in the bladder may be a medication (e.g. an asthma medication) which when injected into the fluid flow may atomize and be respired by a patient. Furthermore, the embodiments described in FIGS. 1-9 may be large scale systems utilized in water treatment plants, chemical plants where the injection of a fluid is needed, etc.

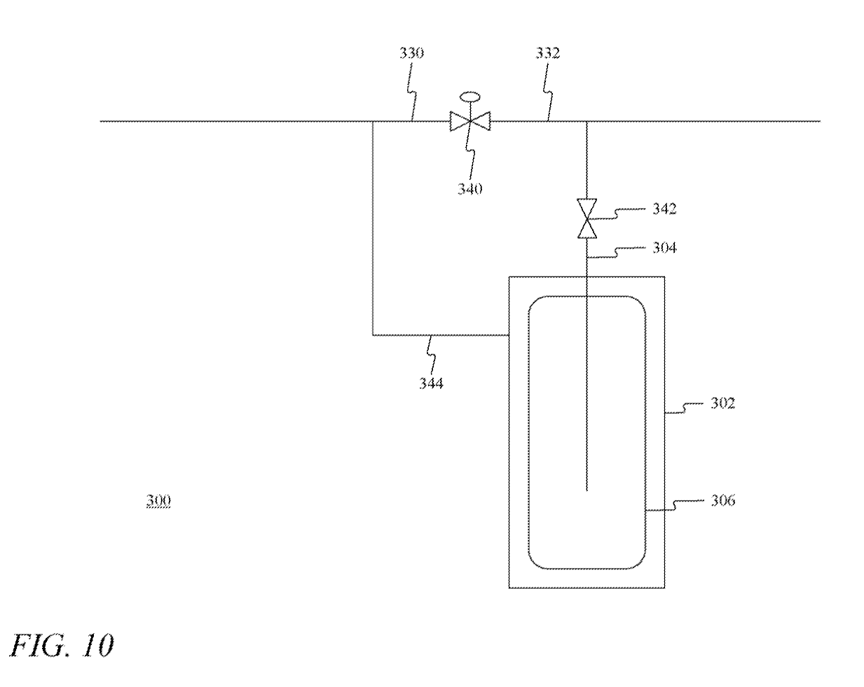

FIG. 10 depicts a schematic of a system 300 for injecting a fluid into a reverse osmosis system. The system 300 includes a container 302, a capillary tube 304, a bladder 306, a valve 340 and a valve 342. Valve 342 may be a dispensing valve. In addition, while not shown, the embodiments of FIG. 10 may include a perforate tube for helping to maintain the capillary tube 304 in a desired shape, act to keep the inlet of the capillary tube 304 from becoming blocked by the bladder 306. Furthermore, the perforated tube may also prevent part of the bladder 306 from pinching off as described with reference to FIGS. 1-9.

During operation, a portion of water flows into container 302 and may apply pressure to the bladder 306. The pressure exerted on the bladder 306 causes scale inhibitor to flow through the capillary tube 304 into the reverse osmosis system. Valve 340 may be configured to restrict the water flow resulting in a pressure difference between points 330 and 332. The pressure at point 330 is approximately equal to that of the pressure applied to the bladder 306. The pressure at point 332 is lower than the pressure at point 330 resulting inflow of the scale inhibitor.

As with continuous flow embodiments, the flow rate of the scale inhibitor may be controlled by a pressure difference from the inlet and the exit of the capillary tube 304. The pressure drop across the capillary tube 304 may be controlled by the diameter and/or length of the capillary tube 304. Other ways to control the flow rate of the scale inhibitor may be to control the pressure applied to the bladder 306. The pressure applied may be controlled by the valve 340. Furthermore, the flow of scale inhibitor may further be controlled by valve 342. Valve 340 may be a pressure differential valve.

For example, a sensor may monitor the concentration of scale inhibitor within the reverse osmosis system. Upon detecting that the concentration of scale inhibitor has fallen below or exceeded preset levels, the sensor may send a signal to valve 342. The signal may cause valve 342 to open and/or close thereby dosing and/or halting flow of scale inhibitor into the reverse osmosis system. In other embodiments, the sensor may send a signal to valve 340. The signal may cause valve 340 to open and/or close thereby adjusting the pressure applied to the bladder 306. This adjustment of pressure may cause the flow of scale inhibitor to increase and/or decrease.

While FIG. 10 depicts two valves 340 and 342 being used to control the pressure applied to the bladder 306 and the flow of fluid from the bladder 306. It is contemplated that either and/or both valves 340 and 342 may be removed from the system. For example, in an embodiment of the present invention, valve 342 may be removed and valve 340 may be adjusted to control the flow of fluid from the bladder 306. Still consistent with embodiments of the present invention, valve 340 may be removed and valve 342 may be adjusted to control the flow of fluid from the bladder 306. Still further consistent with embodiments of the present invention, both valves 340 and 342 may be removed from the system 300 and the diameter and/or length of circulation loop 344 may be used to control the pressure applied to the bladder 306 (i.e. the flow of fluid from the bladder 306). In addition, regardless of the valve combination being implemented, a pump (not shown) may be located in circulation loop 344 or elsewhere within the system 300 to control the pressure applied to the bladder 306. Circulation loop 344 may be a plumbing loop or other piping configuration to divert a portion such that the fluid applies pressure to the bladder 306.

The embodiments described in FIG. 10 may be compact systems which may be utilized in various contexts. For example, the embodiments described in FIG. 10 may be utilized in a residential setting, a laboratory setting, and/or a medical/dental setting. Furthermore, the embodiments described in FIG. 10 may be large scale systems utilized in water treatment plants, chemical plants where the injection of a fluid is needed, etc.

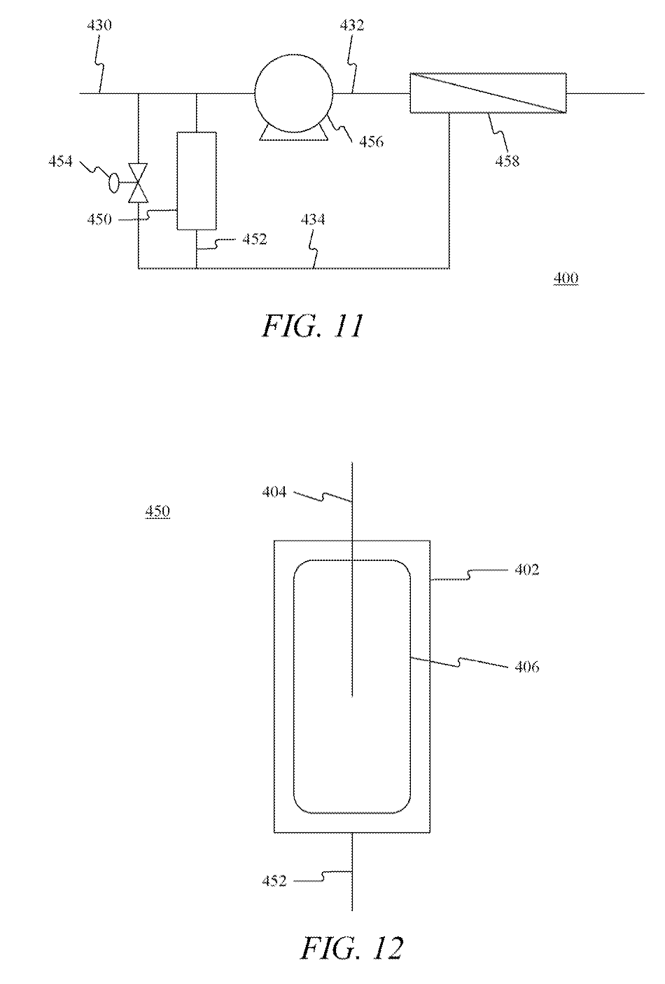

FIG. 11 depicts a schematic of a system 400 for injecting a fluid into a system. The system 400 includes a container assembly 450 (See FIG. 12), a capillary tube 404, a bladder 406, a valve 454 and a pump 456. In addition, while not shown, the embodiments of FIG. 11 may include a perforated tube for helping to maintain the capillary tube 404 in a desired shape, act to keep the inlet of the capillary tube 404 from becoming blocked by the bladder 406. Furthermore, the perforated tube may also prevent part of the bladder 406 from pinching off as described with refernece to FIGS. 1-9.

During operation, incoming water pressure is increased by the pump 456. The increased pressure is symbolized by reference numerals 430 and 432, where the pressure at point 430 is less than 432. The increase in pressure may be adjusted depending on operation conditions, performance requirements, etc. The water may be separated by a membrane 458. A portion of the water recirculates through pipe 434 into the container assembly 450. The water in the container assembly 450 applies a pressure approximately equal to the increase in pressure (point 452) to the bladder 406.

As with continuous flow embodiments, the flow rate of the scale inhibitor is controlled by a pressure difference from the inlet and the exit of the capillary tube 404. The pressure drop across the capillary tube 404 may be controlled by the diameter and/or length of the capillary tube 404. For example, the pressure difference may be 10.89 ATM (160 psi) or more, and may require the capillary tube 404 to have small inside diameter (e.g. 0.127 mm (5 mils)) and a length of 1.0 meters (˜3 ft) or greater.

Other ways to control the flow rate of the scale inhibitor may be to control the pressure applied to the bladder 406. The pressure applied to the bladder 406 may be controlled by the valve 454. Valve 454 may be used to reduce the pressure to a pressure approximately equal to that of point 430 prior to introduction back into a main flow. The pressure applied to the bladder 406 causes the scale inhibitor to flow into the system. Furthermore, the valve 454 and/or the pump 456 may be controlled by a sensor. The sensor may monitor the pressure and/or the concentration of scale inhibitor within the system and adjust the valve and/or the pump accordingly.

For example, a sensor may monitor the concentration of scale inhibitor within a reverse osmosis system. Upon detecting that the concentration of scale inhibitor has fallen below or exceeded preset levels, the sensor may send a signal to the valve 454. The signal may cause the valve 454 to open and/or close thereby dosing and/or halting flow of scale inhibitor into the reverse osmosis system. In other embodiments, the sensor may send a signal to the pump 456. The signal may cause the pump 456 to increase and/or decrease the pressure thereby adjusting the pressure applied to the bladder 406. This adjustment of pressure may cause the flow of scale inhibitor to increase and/or decrease.

The embodiments described in FIG. 11 may be compact systems which may be utilized in various contexts. For example, the embodiments described in FIG. 11 may be utilized in a residential setting, a laboratory setting, and/or a medical/dental setting. Furthermore, the embodiments described in FIG. 11 may be large scale systems utilized in water treatment plants, chemical plants where the injection of a fluid is needed, etc.

While the embodiments described in this specification depict the capillary tube being partially located inside the container and/or bladder, it is contemplated that the in various embodiments of the invention, capillary tube may be located completely inside the container and completely exterior to the bladder. Still consistent with embodiments of the present invention, the capillary tube may be located completely exterior to both the container and the bladder. Furthermore, it is contemplated that the capillary tube may be completely located inside the container and the bladder. The general principle is that the fluid flows through the capillary tube before being injected into the system. The actual location and method by which the capillary tube is connected to the bladder is inconsequential.

The desired length, diameter, and/or applied pressure may vary depending upon a desired scale inhibitor flow rate. The pressures are independent of the systems size. A small system may have a high pressure and a large system may have a low pressure. The key is the pressure differential, not the absolute pressure. For example, in systems with a low pressure differential (e.g. 0.07 to 0.34 ATM (1 to 5 psi)) the capillary tube may have a length from 2.54-15.25 cm (1 to 6 inches) and a diameter of around 0.127 mm (5 mil). In a system with a high differential pressure (8.17 ATM (120 psi)) the capillary length may be 1.83 m (6 ft) or longer. Moreover, while the capillary tubes in this specification have been described as straight tubes, it is contemplated that the capillary tube may be a variety of shapes. For example, the capillary tube may be a coil. Furthermore, the diameter of the capillary tube may range from 0.1 mm and up. The desired length, diameter, and/or applied pressure may be determined using standard equations found in a standard text on fluid mechanics.

Throughout this specification, the container that houses the fluid to be injected into a system is referred to as a bladder. However, the term bladder is intended to imply that the container is any container that deforms upon the application of pressure. The deformation causes the fluid within the bladder to flow from the bladder.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system for delivering a first fluid, the system comprising:
a first container;
a bladder located inside the container; and
a capillary tube having an inlet and an exit, the capillary tube being configured to release the first fluid from the bladder when there exists a pressure difference between the inlet of the capillary tube and the exit of the capillary tube, the pressure difference being caused by the configuration of the container and associated plumbing.

2. The system of claim 1 wherein the fluid comprises at least one of a scale inhibitor, a dental solution, and a medication solution.

3. The system of claim 1 further comprising a perforated enclosure located within the bladder and configured to surround a portion of the capillary tube.

4. The system of claim 1 wherein the first container being configured to be inserted into a second container, the first container and the second container being configured to allow a second fluid to flow from the second container into the first container and exit the system.

5. The system of claim 1 further comprising a fitting configured to divert a portion of a second fluid flow into the first container.

6. The system of claim 1 further comprising a dispensing valve configured to restrict flow of the first fluid from the capillary tube.

7. The system of claim 1 further comprising a pump configured to cause the pressure difference between the inlet of the capillary tube and the exit of the capillary tube.

8. A method for injecting a first fluid into a system, the method comprising:
causing a pressure differential between an inlet of a capillary tube and an outlet of the capillary tube; and
forcing the first fluid to flow from a bladder through the capillary tube into the system in response to the pressure differential.

9. The method of claim 8 wherein an amount of the first fluid injected into the system is determined by adjusting at least one of the length and the inside diameter of the capillary tube.

10. The method of claim 8 further comprising:
monitoring the concentration of the first fluid in the system; and
adjusting the flow of the first fluid from the bladder into the system in response to monitoring the concentration of the first fluid in the system.

11. The method of claim 8 further comprising:
monitoring the flow of the first fluid from the bladder; and
metering the flow of the first fluid from the bladder in response to monitoring the flow of the first fluid from the bladder.

12. The method of claim 8 wherein the fluid comprises at least one of a scale inhibitor, a dental solution, and a medication solution.

13. A system for delivering a first fluid, the system comprising:
a first container;
a bladder containing the first fluid is located within the first container;
a capillary tube, having an inlet and an outlet, positioned in association with the bladder to all the first fluid to exit the bladder; and
a first throttling device operatively configured to cause a pressure differential between the inlet and the outlet of the capillary.

14. The system of claim 13 wherein the first fluid comprises at least one of a scale inhibitor, a dental solution, and a medication solution.

15. The system of claim 13 further comprising a perforated enclosure configured to allow the first fluid to enter the capillary tube and hinder blocking the inlet of the capillary tube.

16. The system of claim 13 further comprising a circulation loop configured to divert a portion of a flow into the first container.

17. The system of claim 13 further comprising a pump configured to control the pressure differential between the inlet and the outlet of the capillary.

18. The system of claim 13 further comprising a second throttling device for restricting flow of a second fluid into the first container.

19. The system of claim 18 wherein the first throttling device is an electromechanical valve.

20. The system of claim 18 wherein the first throttling device is a solenoid valve.
